(19) United States
(12) Patent Application Publication
(10) Pub. No.: US 2025/0143334 A1
(43) Pub. Date: May 8, 2025

(54) LIQUID OAT COMPOSITION AND METHOD FOR PRODUCTION THEREOF

(71) Applicant: Oatly AB, MALMÖ (SE)

(72) Inventors: Linda JOHANSSON, MALMÖ (SE); Matilda ULMIUS STORM, MALMÖ (SE); Karin PETERSSON, MALMÖ (SE); Sofia EHLDE, MALMÖ (SE)

(21) Appl. No.: 18/726,095

(22) PCT Filed: Dec. 30, 2021
(86) PCT No.: PCT/EP2021/087834

§ 371 Date: Jul. 1, 2024

(51) Int. Cl. A23C 11/10; A23J 3/14; A23J 3/34; A23L 7/104; A23L 9/20

(52) U.S. Cl. CPC A23C 11/10; A23J 3/14; A23J 3/346; A23L 7/107; A23L 9/24

(57) ABSTRACT

The disclosure concerns a liquid oat composition for coffee or tea whitening. The liquid oat composition comprises an oat derived material with 5-20% by weight dry substance, based on the weight of the liquid oat composition. According to the disclosure, the liquid oat composition has an oat protein deamidation degree of at least 10%. A method for production thereof is also disclosed.

### TECHNICAL FIELD

The present disclosure relates to a liquid oat composition for coffee or tea whitening, and a process for producing thereof. In particular, the disclosure relates to a liquid oat composition comprising an oat derived material with 5-20% by weight dry substance, based on the weight of the liquid oat composition.

### BACKGROUND

Oat based drinks for use as milk substitutes and as a raw material for other non-dairy products, such as oat yoghurt, oat batter, or as a food additive in general are known in the art. These oat-based milk substitutes are preferred by many customers for various reasons, such as for example content of soluble β-glucan fiber beneficial to health, lack of potentially allergenic proteins, and lack of lactose which cannot be digested by the majority of the global population.

In spite of the commercial success of these oat-based milk substitutes available on the market, there is room for further improvement, particular in respect of improved stability, mouthfeel and foaming capacity when used for coffee or tea whitening, and especially when used together with strong coffee, and when used for barista applications, such as steaming capability, latte art etc.

### SUMMARY

An object of the disclosure is to fully or partly provide a liquid oat composition for coffee or tea whitening with improved stability, and mouthfeel, while maintaining foaming capacity.

According to a first aspect of the disclosure, these and other objects are achieved, in full or at least in part, by a liquid oat composition for coffee or tea whitening, comprising an oat derived material with 5-20% by weight dry substance, based on the weight of the liquid oat composition. According to this first aspect of the disclosure, the liquid oat composition has an oat protein deamidation degree of at least 10%.

By ensuring that the oat protein deamidation degree has reached this level, a liquid oat composition is, when poured into hot coffee or tea, more stable, has a better mouthfeel, and provides less feathering than prior art compositions.

The liquid oat composition may have an oat protein deamidation degree of at least 11%, or at least 20% or at least 23%.

This may be achieved by subjecting the oat protein for deamidation with protein-deamidase, preferably protein-glutaminase. Such deamidation improves solubility of the protein in aqueous solution. In addition, solubility may be improved accordingly without degradation of the proteins. Therefore, use of protein-deamidase in the context of the present disclosure allows presence of intact, or non-degraded, proteins to be comprised by the liquid oat composition in water soluble form. According to one example at least 1.5 U of protein-deamidase was used per gram oat protein, in another example at least 2 U/g of oat protein was used, in one example 3U/g of oat protein was used, and in another example 4U/g of oat protein was used. However, according to another example 1U/g of oat protein was used, but the deamidation was performed during a sufficient time period to reach an oat protein deamidation degree of at least 10%, at least 11%, at least 20% or at least 23%.

The liquid oat composition may further comprise a buffer in an amount applicable to buffer 150 ml of coffee (strong coffee) to a pH of at least 5.7 when adding 20 ml liquid oat composition. 150 ml equals a normal sized coffee cup. The liquid oat composition may comprise a buffer in an amount applicable to buffer 150 ml coffee to a pH of at least 5.9 when adding 20 ml liquid oat composition.

By tailoring both the deamidation degree and the amount of added buffer, the stability of the liquid oat composition, when used in hot coffee or tea, is increased even further. The added buffer also provides the advantage of allowing use of minor amount of the liquid oat composition into hot coffee or tea without giving rise to feathering.

Normal amount of liquid oat composition for coffee or tea whitening is about 30-50 ml per 150 ml coffee/tea. With the tailoring of deamidation alone to at least 10%, at least 11%, at least 20% or at least 23%, or in combination with a buffer in an amount applicable of buffering 150 ml of coffee to a pH of at least 5.7 when adding 20 ml liquid oat composition, also minor amount, like 20 ml or even 10 ml of the liquid oat composition may be used for whitening 150 ml coffee or tea without any stability issues like feathering.

The buffer may be one or more selected from group comprising potassium phosphates, potassium citrates, sodium citrates, calcium phosphates, calcium carbonates, and potassium carbonates. Calcium phosphates and calcium carbonates may also be added for mineral supplement reasons, but these also have a buffering effect to some extent.

The liquid oat composition may comprise at least 0.35% by weight, at least 0.48% by weight, at least 0.54% by weight, or at least 0.64% by weight of di-potassium phosphate, based on the total weight of the composition.

The liquid oat composition may comprise 0.48% by weight of di-potassium phosphate and 0.01-0.05% by weight of potassium carbonate, based on the total weight of the composition.

The liquid oat composition may comprise 0.84% by weight of tri-potassium citrate and 0.32% by weight of calcium carbonate; or 0.31% by weight of calcium carbonate, 0.17% by weight of trisodium citrate dihydrate, and 0.058% by weight of potassium carbonate; or 0.35% by weight of di-potassium phosphate, 0.20% by weight of calcium carbonate, 0.10% by weight of tri-calcium phosphate, and 0.05% by weight of di-calcium phosphate calcium based on the total weight of the composition.

The liquid oat composition may further comprise partially hydrolyzed oat starch comprising oligosaccharides. One or more of α-amylase and β-amylase may be used for the hydrolyzation. Thereby, the oat liquid composition may comprise one, more or all of monosaccharides, disaccharides, for example, maltose, and oligosaccharides. According to this the oat starch may only to some extent be hydrolyzed so that the liquid oat composition maintains a mouthfeel when consumed as such or when added to coffee or tea. The oat starch may be hydrolyzed to mono- and/or disaccharides, such as maltose, at a level of 0-45% by weight, based on dry weight of the oat derived material.

The liquid oat composition may comprise 5-20% by weight of protein, 3-30% by weight of fat, and optionally 10-80% by weight of carbohydrates including sugars, based on the dry weight of the oat derived material.

The liquid oat composition may comprise water soluble β-glucans having a molecular weight of 50,000 Da or more, such as 100,000 Da or more. The water soluble β-glucans may be comprised by the oat derived material. The oat derived material may comprise 2-6% by weight of β-glucans, based on dry weight of the oat derived material.

It is unexpected and beneficial with the liquid oat composition of the present disclosure that the composition, even when comprising a complex mixture of, for example, protein and one or more of monosaccharides, disaccharides, and β-glucans, may be added to coffee and maintain stability without feathering. In addition, the liquid oat composition may be foamed and may form a foam stable over at least several minutes, and, thus, be useful for barista applications where foamed milk substitute is desirable. The combination of stability without feathering and ability to foam makes the liquid oat composition desirable for coffee or tea whitening.

The oat derived material may be obtainable by or obtained from heat-treated oats, such as steamed oat kernels. The oat kernels may further be micronized, such as milled or crushed. The oat derived material may be selected from heat-treated wet milled oats, heat-treated dry milled oats, heat-treated oat bran, heat-treated dehulled or hulled/naked dry milled oat flour.

According to a second aspect of the disclosure, these and other objects are also achieved, in full or at least in part, by a method for production of a liquid oat composition for coffee or tea whitening comprising an oat derived material with 5-20% by weight dry substance based on the weight of the liquid oat composition. According to this second aspect, this method comprises subjecting the oat protein within the liquid oat composition for a protein-deamidase to reach a deamidation degree of at least 10%.

According to this second aspect of the disclosure, the oat protein within the liquid oat composition may be subjected for a protein-deamidase to reach a deamidation degree of at least 11%, at least 20% or at least 23%.

According to this second aspect of the disclosure, the protein-deamidase may be protein-glutaminase.

According to this second aspect of the disclosure, the method may further comprise the step of subjecting the oat starch for partial hydrolysis by amylase. The amylase may be one or more of α-amylase and β-amylase.

According to this second aspect of the disclosure, the deamidation and hydrolysis may be performed concurrently.

The method may further comprise a step of adding a buffer to the liquid oat composition in an amount applicable to buffer 150 ml coffee to a pH of at least 5.7 when adding 20 ml liquid oat composition. The buffer may be added in an amount applicable to buffer 150 ml coffee to a pH of at least 5.9 when adding 20 ml liquid oat composition. The buffer may be one or more selected from group comprising potassium phosphates, potassium citrates, sodium citrates, calcium phosphates, calcium carbonates and potassium carbonates. Calcium phosphates and calcium carbonates may also be added for mineral supplement reasons, but these also have a buffering effect to some extent.

The buffer may be di-potassium phosphate, and be added in an amount of at least 0.35% by weight, at least 0.48% by weight, at least 0.54% by weight, or at least 0.64% by weight, based on the total weight of the composition.

The buffer may be added as a combination of di-potassium phosphate and potassium carbonate, and may comprise 0.48% by weight of di-potassium phosphate and 0.01-0.05% be weight of potassium carbonate, based on the total weight of the composition.

The buffer may be added as 0.84% by weight of tri-potassium citrate and 0.32% by weight of calcium carbonate; or 0.31% by weight of calcium carbonate, 0.17% by weight of trisodium citrate dihydrate, and 0.058% by weight of potassium carbonate; or 0.35% by weight of di-potassium phosphate, 0.20% by weight of calcium carbonate, 0.10% by weight of tri-calcium phosphate, and 0.05% by weight of di-calcium phosphate calcium, based on the total weight of the composition.

The oat used for producing the liquid oat composition may be heat-treated prior to use as a starting material for producing the liquid oat composition. A purpose of the heat treatment is to reduce lipase activity in the oats.

Similarly, and correspondingly to the liquid oat composition of the first aspect, the method of this second aspect will provide substantial advantages over prior art solutions.

Other objectives, features and advantages of the present disclosure will appear from the following detailed disclosure, and from the attached claims. It is noted that the disclosure relates to all possible combinations of features and combinations of examples.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

As used herein, the term “comprising” and variations of that term are not intended to exclude other additives, components, integers or steps.

### Definitions

The term “oat protein deamidation degree” is defined as the enzymatic deamidation of the liquid oat composition by protein-deamidase in comparison with total deamidation by acid treatment of the same liquid oat composition. When deamidation takes place in a liquid oat composition, ammonia is formed within the liquid oat composition, and it is the amount of formed ammonia by enzymatic deamidation which is compared to the amount of formed ammonia by acid deamidation of the liquid oat composition. For details concerning methodology for the measurements, please see below under “MATERIAL AND METHODOLOGIES”.

The term “buffer in an amount applicable to buffer 150 ml coffee to a pH of at least 5.7 (or at least 5.9) when adding 20 ml liquid oat composition” means the amount of buffer within the liquid oat composition that is needed to buffer 150 ml coffee (strong coffee, see below for further details) to a pH of at least 5.7 (or at least 5.9) when 20 ml of liquid oat composition is added to the 150 ml coffee (strong coffee, see below for further details).

The term “oat derived material” means material derived from oats. The oats used for the oat derived material may be in form of heat-treated oat kernels, such as steamed oat kernels. The oat kernels may further be micronized, such as milled or crushed. The oat derived material may be selected from heat-treated wet milled oats, heat-treated dry milled oats, heat-treated oat bran, heat treated dehulled or hulled/naked dry milled oat flour. The oat derived material may comprise oat proteins, oat starch, oat fats, and oat fibers. The raw material for the oat derived material may be prepared from oats by milling groats with water to obtain a mixture comprising 5-20% by weight of dry substance, based on the weight of the liquid oat composition.

The term “feathering” means flaking, curdling or flocculation of milk or a milk substitute in coffee or tea. Feathering is non-desirable as it may indicate or be perceived as sourness of the milk or the milk substitute to a consumer. However, feathering does not produce a sour taste in the coffee, yet it gives an unpleasing appearance and mouthfeel.

### Material and Methodologies

The oat protein deamidation degree is determined by comparing the enzymatically deamidation of the liquid oat composition with totally deamidated liquid oat composition, wherein the total deamidation is performed by acid treatment. When determining the oat protein deamidation degree, it is the % of formed ammonia within the liquid oat composition in comparison with the total amount of formed ammonia of the liquid oat composition, which is measured. The amount of ammonia within the liquid oat composition is a result of the deamidation of the liquid oat composition, and this amount is compared with the amount of ammonia within the liquid oat composition when the liquid oat composition has been treated to complete deamidation.

### Preparation of the Samples for Measurement:

To determine ammonia content in a liquid oat composition (deamidated enzymatically), the liquid oat composition is deproteinized by 10 kDa spin-filters (Amicon Ultra) and the filtrate is used for the ammonia analysis below.

For determine total amount of formed ammonia within a liquid oat composition (total deamidation by acid treatment), the liquid oat composition is mixed with sulphuric acid to reach 2N sulphuric acid, the sample is kept in a boiling water bath for 4 hours and cooled down to room temperature, and neutralized by 4M NaOH. The sample is centrifuged, 5000×g for 10 min, and the supernatant is diluted 10× and used directly for the ammonia analysis below.

### Ammonia Analysis:

Megazyme Ammonia Assay Kit Rapid (K-AMIAR) following the provided protocol by Megazyme (see www.megazyme.com).

### Coffee Stability Analysis:

The coffee used for testing the stability of the liquid oat composition according to this disclosure was, unless otherwise identified in the examples below, medium roasted coffee beans, prepared as a strong coffee by mixing 7.9% grinded coffee in boiling water using a French press for 4 min, and a volume of 150 ml prepared coffee was used for each test.

The stability of the liquid oat compositions when poured into 150 ml coffee was investigated by ocular review of the coffee having liquid oat composition poured therein, in a glass beaker. Especially the degree of feathering was investigated. Minor feathering can be described as visually small, light-colored fragments while extensive feathering can be described as visually light-colored fragments that appear immediately, and that either grow in size or increase in number during the first minutes after combining liquid oat composition with coffee.

### DETAILED DESCRIPTION

The present disclosure will now be described more fully hereinafter. The present disclosure may, however, be embodied in many different forms and should not be construed as limited to the examples set forth herein; rather, these examples are provided for thoroughness and completeness, and to fully convey the scope of the disclosure to the skilled addressee.

As discussed above, the present disclosure concerns an improved oat-based milk substituent, with a focus of improving the stability mouthfeel of the oat based milk substitute or analogue when used in coffee or tea for whitening. The variety of barista coffee drinks are increasing year by year, also concerning the choice of coffee beans and the degree of roasting of the coffee beans. Most common and traditional are dark and medium roasted coffee beans, but light roasted coffee beans are one upcoming alternative.

The different coffee beans and the degree of roasting of the coffee beans have different demands on an oat-based milk substituent when used therein for whitening. The added amount of oat-based milk substituent may also vary.

These changes in barista applications demand an improved liquid oat composition which is persistent in its delivery in stability, mouthfeel and foaming capability independently to what type of coffee it is added, and also in what amount it is added. The present disclosure delivers in full or at least in part to these requests.

The present inventors have, after extensive research and development, found that the degree of deamidation of the oat protein within the liquid oat composition must be at least 10%, at least 11%, at least 20% or at least 23% in order to provide a liquid oat composition that, when poured into hot coffee or tea, is more stable and have a better mouthfeel than prior art compositions. This deamidation degree is achieved by subjecting the oat protein for deamidation with protein-deamidase, preferably protein-glutaminase either with a sufficiently high concentration or for a sufficient long period of time to reach a deamidation degree of at least 10%, at least 11%, at least 20% or at least 23%. In terms of process efficiency, one option is to provide a sufficiently high concentration of protein-deamidase in order to reach the deamidation degree within a fairly short process time. However, the same deamidation degree may be reach by using a lower concentration of protein-deamidase but during a longer process time.

By ensuring a deamidation degree of at least 10%, at least 11%, at least 20% or at least 23%, the resulting liquid oat composition is more stable when used for coffee whitening.

However, the liquid oat composition may be further improved by adding a buffer to the liquid oat composition, and especially by adding a buffer in an amount applicable to buffer 150 ml coffee (a normal size of a cup of coffee) to a pH of at least 5.7, or 5.9 when adding 20 ml liquid oat composition to the 150 ml coffee. By tailoring the degree of deamidation and the amount of buffer, a liquid oat composition is provided which is stable for use in a variety of coffee or tea and also in such small amounts as 20 ml, and even as small amount as 10 ml to a cup of coffee. A cup of coffee corresponds to approximately to 150 ml of coffee.

Especially a combination of a lower degree of deamidation (at least 10%) and a larger amount of buffer (applicable to buffer 150 ml of coffee to a pH of at least 5.9 when adding 20 ml) or a higher degree of deamidation (at least 20%) and a smaller amount of buffer (applicable to buffer a cup of coffee to a pH of at least 5.7 when adding 20 ml) has proven to provide liquid oat compositions usable in most sorts of coffee or tea.

However, also only using a very high degree of deamidation (at least 23%) and only smaller amount of buffer (not necessarily applicable to buffer a cup of coffee to a pH of at least 5.7 when adding 20 ml of the liquid oat composition to the 150 ml coffee) has proven to provide liquid oat compositions usable in most sorts of coffee with a very small amount of liquid oat composition added therein.

One example of how the liquid oat composition is prepared is described below, but the liquid oat composition may also be prepared in other ways as well without departing from the claimed subject matter.

The raw material in form of heat-treated dehulled oats is prepared by milling groats with water to obtain a mixture comprising 5-20% by weight of dry substance. Protein-deamidase is added to the mixture in an amount and during a period of time sufficient to reach a deamidation degree of at least 10%, at least 11%, at least 20% or at least 23%.

Amylase(s) may also be added simultaneously as the protein-deamidase or before or thereafter, and the oat starch is partially degraded/hydrolyzed at 50-75° C. during a period of time to provide mono- and/or disaccharides, such as maltose, at a level of 0-45% by weight, based on dry weight of the oat derived material. The amylase(s) is one or more of α-amylase and β-amylase.

After deamidation and optional oat starch hydrolysis, enzyme activity is destroyed by heating the product. The mixture is cooled and optionally decanted. Decantation may be omitted if a whole grain product is to be produced.

Thereafter, the mixture or the supernatant after decanting the mixture is formulated into a liquid oat composition by adding one or more of vegetable oil, vitamins, sodium chloride, one or more buffers and one or more of mineral supplements.

The buffer may be added to the liquid oat composition in an amount applicable to buffer 150 ml of coffee (normal size of a cup of coffee) to a pH of at least 5.7, or at least 5.9 when adding 20 ml of the liquid oat composition.

The liquid oat composition may thereafter be subjected to UHT treatment and thereafter be packaged.

### Example 1—Deamidation Degree

Samples of liquid oat compositions having different degree of deamidation was prepared as disclosed above.

All samples comprised the buffer di-potassium phosphate in an amount of 0.48% by weight, based on the total weight of the composition.

The different liquid oat compositions were tested for stability when adding different amounts of the composition to 150 ml of strong coffee, and the stability was classified as excellent, good, and not OK. “Excellent” means that no feathering was evident when the sample was poured into the coffee, “Good” means that minor feathering might occurred within 4 minutes after the sample has been poured into the coffee, and “Not OK” means that extensive feathering occurred when the sample was poured into the coffee.

TABLE 1

| | Deamidation | 10 ml added to | | 20 ml added to | | 30 ml added to | |
|---|---|---|---|---|---|---|---|
| | degree | 150 ml coffee | | 150 ml coffee | | 150 ml coffee | |
| Sample | (%) | Stability | pH | Stability | pH | Stability | pH |
| 1 | 11 | Not OK | 5.6 | Not OK | 5.8 | Excellent | 6.0 |
| 2 | 20 | Not OK | 5.7 | Good | 5.8 | Excellent | 5.9 |
| 3 | 23 | Excellent | 5.6 | Excellent | 5.9 | Excellent | 5.9 |
| Comp.¹⁾ | 8 | Not OK | 5.3 | Not OK | 5.7 | Not OK | 5.8 |

¹⁾Comp. = Comparison sample

From Table 1 it is evident that using a high degree of deamidation will provide a liquid oat composition which is more stable when used for whitening of coffee.

### Example 2—Deamidation Degree/Buffering Capacity

Samples of liquid oat compositions having different degree of deamidation and different buffering capacities were prepared as disclosed above to reach a deamidation degree as identified below.

The buffer % by weight, is in this example % by weight of di-potassium phosphate, based on the total weight of the composition.

The different liquid oat compositions were tested for stability when adding different amounts of the composition to 150 ml of strong coffee, and the stability was classified as excellent, good, and not OK. “Excellent” means that no feathering was evident when the sample was poured into the coffee, “Good” means that minor feathering might occurred 4 minutes after the sample haven been poured into the coffee, and “Not OK” means that extensive feathering occurred when the sample was poured into the coffee.

TABLE 2

| | Deamidation | Buffer | 10 ml added to | | 20 ml added to | | 30 ml added to | |
|---|---|---|---|---|---|---|---|---|
| | degree | % by | 150 ml coffee | | 150 ml coffee | | 150 ml coffee | |
| Sample | (%) | weight | Stability | pH | Stability | pH | Stability | pH |
| 1.1 | 11 | 0.48 | Not OK | 5.6 | Not OK | 5.8 | Excellent | 6.0 |
| 1.2 | 11 | 0.65 | Not OK | 5.5 | Not OK | 5.8 | Excellent | 6.1 |
| 1.3 | 11 | 0.73 | Good | 5.6 | Good | 5.9 | Excellent | 6.1 |
| 2.1 | 20 | 0.48 | Not OK | 5.7 | Good | 5.8 | Excellent | 5.9 |
| 2.2 | 20 | 0.65 | Excellent | 5.7 | Excellent | 5.8 | — | — |
| 2.3 | 20 | 0.73 | Excellent | 5.8 | Excellent | 5.9 | — | — |
| 3.1 | 23 | 0.48 | Excellent | 5.6 | Excellent | 5.9 | — | — |
| Comp. 1 | 8 | 0.48 | Not OK | 5.3 | Not OK | 5.7 | Not OK | 5.8 |
| Comp. 2 | 8 | 0.65 | Not OK | 5.4 | Not OK | 5.8 | Good | 6.1 |
| Comp. 3 | 8 | 0.73 | Not OK | 5.7 | Good | 5.9 | Good | 6.2 |

From Table 2 it is evident that using a combination of high degree of deamidation (20%) with a larger buffering capacity (0.65% by weight in comparison with 0.48% by weight of di-potassium phosphate) will provide a liquid oat composition which show improved stability when added in small amounts (10 ml) for whitening of coffee (see comparison of Sample 2.1 and 2.3).

Further, using a lower degree of deamidation than according to the present disclosure, see sample Comp.1-Comp. 3, a buffering capacity of at least 5.7 is not enough to ensure a stable liquid oat composition when adding 20 ml liquid oat composition to 150 ml coffee (see Comp.1 and Comp. 2 above). Then the liquid oat composition has to provide a buffering capacity of close to a pH of 5.9 or above 6 in order to be stable when adding 20 ml liquid oat composition to 150 ml coffee (see Comp. 3 above), which buffering capacity is provided by an increased amount of buffer in the liquid oat composition.

As seen in Table 2, the buffering capacity is increased with increasing amount of added liquid oat composition. Thus, by adding a larger volume (30 ml) of the liquid oat composition into the 150 ml coffee, a pH of at least 5.9 or above 6 is reached also with Comp. 1 and Comp. 2, and the liquid oat composition is stable after having been poured into the 150 ml coffee.

### Example 3—Light Roasted Coffee

As discussed above, the degree of roasting of coffee beans is effecting the stability of the liquid oat composition when used for coffee whitening. Dark roasted coffee beans are more compatible with the liquid oat composition of the present disclosure than the medium roasted coffee beans, but light roasted coffee beans, which is an upcoming alternative on most Barista menus, are a challenge for milk substituent.

For that reason, the liquid oat composition of the present disclosure was also tested in comparison with coffee made from light roasted coffee beans, using samples 3.1-3.2 above.

The buffer % by weight, is in this example % by weight of di-potassium phosphate, based on the total weight of the composition.

The different liquid oat compositions were tested for stability when added different amounts of the composition to 150 ml of light roasted strong coffee, and the stability was classified as excellent, good, and not OK. “Excellent” means that no feathering was evident when the sample was poured into the coffee, “Good” means that minor feathering might occurred 4 minutes after the sample haven been poured into the coffee, and “Not OK” means that extensive feathering occurred when the sample was poured into the coffee.

TABLE 3

| | Deamidation | Buffer | 20 ml added to 150 ml light | |
|---|---|---|---|---|
| | degree | % by | roasted strong coffee | |
| Sample | (%) | weight | Stability | pH |
| 3.1 | 23 | 0.48 | Not OK | 5.7 |
| 3.2 | 23 | 0.65 | Good | 5.8 |

As seen in table 3, light roasted coffee beans have a higher demand on the liquid oat composition than medium roasted coffee beans. In order to receive a good stability of the liquid oat composition, when added to the coffee for whitening, the liquid oat composition needs to have an increased buffering capacity, as seen for sample 3.2 showing a good stability, while sample 3.1 is not good enough eventhough a pH close to 5.7 is reached within the 150 ml coffee after addition of 20 ml of the liquid oat composition.

### Example 4—Alternative Buffers

In the examples above, di-potassium phosphate has been used as a buffer. However, as previously indicated, also other buffers are possible, such as one or more selected from group comprising potassium phosphates, potassium citrates, sodium citrates, and potassium carbonates.

In this example, as indicated in table 4.1, different combinations of buffers were tested within a liquid oat composition having the below given deamidation degrees.

TABLE 4

| | Deamidation | Buffer(s) added (% by weight based on the | | | | |
|---|---|---|---|---|---|---|
| Sam- | degree | total weight of the liquid oat composition) | | | | |
| ple | (%) | DKP³⁾ | K-Cit⁴⁾ | Na-Cit⁵⁾ | K-Carb⁶⁾ | Ca-Carb⁷⁾ |
| 4.1 | 20 | 0.48 | 0.1 | | | |
| 4.2 | 20 | 0.48 | 0.3 | | | |
| 4.3 | 20 | 0.48 | | 0.05 | | |
| 4.4 | 20 | 0.48 | | 0.2 | | |
| 4.5 | 20 | 0.48 | | | 0.01 | |
| 4.6 | 20 | | | | 0.05 | |
| 4.7 | 8 | | 0.84 | | | 0.32 |
| 4.8 | 20 | | 0.83 | | | 0.32 |
| 4.9 | 20 | | | 0.17 | 0.06 | 0.31 |

³⁾DKP is di-potassium phosphate
⁴⁾K-Cit is potassium citrate
⁵⁾Na-Cit is sodium citrate
⁶⁾K-Carb is potassium carbonate
⁷⁾Ca-Carb is calcium carbonate

In table 4.2 below, the different samples of liquid oat compositions having different buffer(s) were investigated when added in different volumes to 150 ml strong (medium roasted) coffee.

The different liquid oat compositions were tested for stability when added different amounts of the composition to 150 ml of strong coffee, and the stability was classified as excellent, good, and not OK. “Excellent” means that no feathering was evident when the sample was poured into the coffee, “Good” means that minor feathering might occurred 4 minutes after the sample haven been poured into the coffee, “Not OK” means that extensive feathering occurred when the sample was poured into the coffee.

TABLE 4

| | 10 ml added to | | 20 ml added to | | 30 ml added to | | 40 ml added to | |
|---|---|---|---|---|---|---|---|---|
| Sam- | 150 ml coffee | | 150 ml coffee | | 150 ml coffee | | 150 ml coffee | |
| ple | Stability | pH | Stability | pH | Stability | pH | Stability | pH |
| 4.1 | Not OK | 5.4 | Not OK | | Good | 5.9 | Good | 6.0 |
| 4.2 | Not OK | 5.5 | Good | | Good | 6.0 | Good | 6.2 |
| 4.3 | Not OK | 5.4 | Good | 5.7 | Good | 6.0 | Good | 6.0 |
| 4.4 | Not OK | 5.5 | Good | 5.8 | Good | 6.1 | Good | 6.1 |
| 4.5 | Not OK | 5.5 | Good | 5.8 | Good | 6.0 | Good | 6.1 |
| 4.6 | Not OK | 5.5 | Good | 6.0 | Excellent | 6.2 | Excellent | 6.2 |
| 4.7 | — | — | Not OK | 5.7 | Good | 5.9 | Good | 6.1 |
| 4.8 | — | — | Good | 5.5 | Good | 5.7 | Excellent | 5.8 |
| 4.9 | — | — | Not OK | 5.4 | Good | 5.5 | Good | 5.7 |

From Table 4.2 it is evident that the buffering capacity of the buffer or combination of buffers is of importance for the stability of the liquid oat composition when poured into 150 ml of strong coffee. When providing a pH of at least 5.7 or at least 5.9 within the 150 ml coffee, the liquid oat composition is stable after having been poured into the coffee.

The skilled person realises that a number of modifications of the examples described herein are possible without departing from the scope of the disclosure, which is defined in the appended claims.

1. A liquid oat composition for coffee or tea whitening, comprising an oat derived material with 5-20% by weight dry substance, based on the weight of the liquid oat composition, characterized in having an oat protein deamidation degree of at least 10%.

2. The liquid oat composition according to claim 1, having an oat protein deamidation degree of at least 11%, at least 20% or at least 23%.

3. The liquid oat composition according to claim 1, further comprising a buffer in an amount applicable to buffer 150 ml of coffee to a pH of at least 5.7 when adding 20 ml liquid oat composition.

4. The liquid oat composition according to claim 3, comprising a buffer in an amount applicable to buffer 150 ml coffee to a pH of at least 5.9 when adding 20 ml liquid oat composition.

5. The liquid oat composition according to claim 3, wherein the buffer is one or more selected from group comprising potassium phosphates, potassium citrates, sodium citrates, calcium phosphates, calcium carbonates and potassium carbonates.

6. The liquid oat composition according to claim 1, further comprising partially hydrolyzed oat starch.

7. A method for production of a liquid oat composition for coffee or tea whitening, the liquid oat composition comprising an oat derived material with 5-20% dry substance by weight of the liquid oat composition, which method is characterized by subjecting the oat protein within the liquid oat composition for a protein-deamidase to reach a deamidation degree of at least 10%.

8. The method according to claim 7, wherein the oat protein within the liquid oat composition is subjected for a protein-deamidase to reach a deamidation degree of at least 11%, at least 20% or at least 23%.

9. The method according to claim 7, wherein the protein-deamidase is protein-glutaminase.

10. The method according to claim 7, further comprising the step of subjecting the oat starch for partial hydrolysis by amylase.

11. The method according to claim 10, wherein the amylase is one or more of α-amylase and β-amylase.

12. The method according to claim 11, wherein the deamidation and hydrolysis is performed concurrently.

13. The method according to claim 7, further comprising a step of adding a buffer to the liquid oat composition in an amount applicable to buffer 150 ml coffee to a pH of at least 5.7 when adding 20 ml liquid oat composition.

14. The method according to claim 13, wherein the buffer is added in an amount applicable to buffer 150 ml coffee to a pH of at least 5.9 when adding 20 ml liquid oat composition.

15. The method according to claim 13, wherein the buffer is one or more selected from group comprising potassium phosphates, potassium citrates, sodium citrates, calcium phosphates, calcium carbonates and potassium carbonates.

16. The liquid oat composition according to claim 4, wherein the buffer is one or more selected from group comprising potassium phosphates, potassium citrates, sodium citrates, calcium phosphates, calcium carbonates and potassium carbonates.
